(19) United States
(12) Patent Application Publication
(10) Pub. No.: US 2011/0007956 A1
(43) Pub. Date: Jan. 13, 2011

(54) SINOGRAM PROCESSING TO REDUCE METAL ARTIFACTS IN COMPUTED TOMOGRAPHY

(76) Inventors: Esther Meyer, Erlangen (DE); Rainer Raupach, Heroldsbach (DE)

Correspondence Address: HARNESS, DICKEY & PIERCE, P.L.C., P.O.BOX 8910, RESTON, VA, 20195, US

(21) Appl. No.: 12/824,389

(22) Filed: Jun. 28, 2010

(30) Foreign Application Priority Data
Jul. 7, 2009 (DE) 10 2009 032 059.8

(51) Int. Cl. G06K 9/00

(52) U.S. Cl. 382/131

(57) ABSTRACT

A method is disclosed for reconstructing image data of an examination object from measurement data, wherein the measurement data was captured as projection data during a relative rotational movement between a radiation source of a computed tomography system and the examination object. In at least one embodiment, a first image is determined from the measurement data and pixel values of the first image are modified, by classifying the pixel values in at least three classes, a class pixel value being assigned to each class, and the pixels of the first image being allocated the respective class pixel value. Projection data is calculated from the thus modified first image. The calculated projection data is used to normalize the measured projection data. Values are modified in the normalized projection data and the thus modified normalized projection data is subjected to a processing that reverses normalization. Finally a second image is determined from the thus processed projection data.

### PRIORITY STATEMENT

The present application hereby claims priority under 35 U.S.C. §119 on German patent application number DE 10 2009 032 059.8 filed Jul. 7, 2009, the entire contents of which are hereby incorporated herein by reference.

### FIELD

At least one embodiment of the invention generally relates to a method for reconstructing image data of an examination object from measurement data, the measurement data having been captured as projection data during a relative rotational movement between a radiation source of a computed tomography system and the examination object.

### BACKGROUND

Methods for scanning an examination object using a CT system are generally known. Circular scans, sequential circular scans with advance or spiral scans for example are used here. During such scans absorption data of the examination object is recorded from different recording angles with the aid of at least one x-ray source and at least one detector opposite it and the projection data thus collated is processed by way of suitable reconstruction methods to produce sectional images through the examination object.

To reconstruct computed tomography images from x-ray CT data records of a computed tomography device (CT device), i.e. from the captured projections, the standard method currently used is what is known as a filtered back projection method FBP. After the data has been captured what is known as a rebinning step is carried out, in which the data generated using the beam fanning out from the source is rearranged so that it is present in a form as if the detector were struck by beams traveling to the detector in a parallel manner. The data is then transformed into the frequency domain. Filtering takes place in the frequency domain and the filtered data is then back transformed. The thus rearranged and filtered data is then used for back projection onto the individual voxels within the volume of interest.

Metallic foreign bodies within an examination object, e.g. dental fillings or implanted screws, have an extremely negative influence on the image quality of CT images. The reason for this is that metals absorb x-ray beams to a much greater degree than the rest of the tissue. The metal objects therefore cause striped artifacts to form over large regions of the image and these may conceal relevant information. Artifacts refer to structures in the image, which do not correspond to the actual spatial distribution of the tissue within the examination object.

It is therefore worthwhile to reduce metal artifacts. Some methods for reducing metal artifacts are for example described in
[1] J. Müller and T. M. Buzug, “Spurious structures created by interpolation-based CT metal artifact reduction”, SPIE Medical Imaging Proc., vol. 7258, no. 1, pp. 1Y1-1Y8, March 2009.
[2] W. A. Kalender, R. Hebel, and J. Ebersberger, “Reduction of CT artifacts caused by metallic implants”, Radiology, vol. 164, no. 2, pp. 576-577, August 1987.
[3] A. H. Mahnken, R. Raupach, J. E. Wildberger, B. Jung, N. Heussen, T. G. Flohr, R. W. Günther, and S. Schaller, “A new algorithm for metal artifact reduction in computed tomography: in vitro and in vivo evaluation after total hip replacement”, Investigative Radiology, vol. 38, no. 12, pp. 769-775, December 2003
[4] S. Zhao, D. D. Robertson, G. Wang, B. Whiting, and K. T. Bae, “X-ray CT metal artifact reduction using wavelets: An application for imaging total hip prostheses”, IEEE Transactions on Medical Imaging, vol. 19, no. 12, pp. 1238-1247, December 2000.
[5] M. Kachelrieβ, O. Watzke, and W. A. Kalender, “Generalized multi-dimensional adaptive filtering (MAF) for conventional and spiral single-slice, multi-slice and cone-beam CT”, Med. Phys., vol. 28, no. 4, pp. 475-490, April 2001.
[6] B. De Man, J. Nuyts, P. Dupont, G. Marchal, and P. Suetens, “An iterative maximum-likelihood polychromatic algorithm for CT”, IEEE Transactions on Medical Imaging, vol. 20, no. 10, pp. 999-1008, October 2001.
[7] M. Bal, L. Spies, “Metal artifact reduction in CT using tissue-class modeling and adaptive prefiltering”, Medical Physics, vol. 33, no. 8, pp. 2852-2859, 2006.

### SUMMARY

In at least one embodiment of the invention, a method is disclosed for reconstructing CT images, wherein it is to be taken into account that the examination object may contain metal objects. Also a corresponding control and computation unit, a CT system, a computer program and a computer program product are disclosed.

With at least one embodiment of the inventive method for reconstructing image data of an examination object from measurement data, the measurement data is present as projection data, which was captured during a relative rotational movement between a radiation source of a computed tomography system and the examination object. A first image is determined from the measurement data. Pixel values of the first image are modified by classifying the pixel values in at least three classes, with a class pixel value being assigned to each class and the pixels of the first image being allocated the respective class pixel value. Projection data is calculated from the thus modified first image. The calculated projection data is used to normalize the measured projection data. Values are modified in the normalized projection data and the thus modified normalized projection data is subjected to a processing that reverses normalization. Finally a second image is determined from the thus processed projection data.

A two-fold image reconstruction therefore takes place. First the first image is reconstructed from the measured data. After reworking this is used to determine projection data. This calculated projection data is reworked and then used to reconstruct the second image. This procedure enables artifacts to be reduced; it is particularly suitable for reducing metal artifacts.

Classification takes place during processing of the first image. Each pixel of the first image is preferably classified in one of the three or more classes. Once a pixel has been classified in a particular class, its pixel value is replaced by the class pixel value associated with the respective class. Each class has just one class pixel value.

Therefore instead of a plurality of different pixel values, after reworking the first image therefore contains only a limited number of different pixel values. This number corresponds to the number of classes used. It is also possible just to classify a subset of the pixels of the first image in the classes and to modify the pixel values accordingly.

The projection data calculated from the first image is used to standardize the measured projection data. This standardization can be achieved in different ways, for example by dividing the measured projection data by the calculated projection data. This division preferably takes place point by point; in other words each data item of the measurement data is divided by the corresponding data item of the calculated data.

Once the standardized projection data is obtained, it is reworked. This is done by allocating different values to at least some of said data. The object of this procedure is to modify the projection data so that the image reconstructed therefrom has fewer artifacts than the first image. Accordingly the part of the projection data subject to error or uncertainty can in particular be affected by the value modification. This is preferably just a part of the data; it is however possible for all the data to be modified. Information about which part of the projection data is to be modified can be obtained for example from the projection data calculated from the first image and/or the standardized projection data.

Once the standardized projection data has been modified, the previously undertaken standardization is canceled. This can be done in particular by means of a point by point multiplication by the calculated projection data, in other words each data item of the modified standardized projection data is multiplied by the respectively corresponding data item of the calculated projection data.

In a development of at least one embodiment of the invention the different class pixel values correspond to image values of different types of components of the examination object. The number of classes used can in particular be a function of how many components with clearly different x-ray absorption are present in the part of the examination object under consideration. The examination object here can also include the immediate area around the examination object, so a class image value can also be provided for this area. The different types of component can be air, water and bone for example; this corresponds to the use of three classes. However more than three classes can also be used.

In one embodiment of the invention a top and bottom pixel value are determined for each class and a pixel is classified in the respective class, if its pixel value is between the bottom and top pixel values of the respective class. These are threshold value decisions.

It is particularly advantageous if, in addition to the modification of the first image, a further image is generated, with pixels with pixels being allocated the class pixel value of a further class in the further image. The first image exists after the first image reconstruction. Two images are generated from this first image: on the one hand the modified first image and on the other hand the further image. In contrast to the first image, the further image contains pixel values of the further class. This is a class that is not used for the modified first image. To decide which pixel of the further image should be given this further class pixel value, the procedure is the same as the one used for the other classes. Preferably only the pixels with pixels values other than zero, which are allocated to the further class, are used in the further image.

In one example embodiment of the invention the further class pixel value corresponds to image values of metal components of the examination object. The further image therefore indicates where metal components are located within the examination object. This is not the case for the modified first image, as the further class was not used for this.

In one development of at least one embodiment of the invention further projection data is calculated from the further image and it is concluded from the further projection data which values of the normalized projection data are to be modified. The values to be modified therefore relate exclusively or among others to the pixels of the further class.

It is particularly advantageous if the further projection data indicates the location of a metal trace within the measurement data. It is possible in particular to conclude directly from this where modification is to be carried out in the normalized projection data.

According to one development of at least one embodiment of the invention in the second image the pixel values of pixels, which correspond to the pixels of the further image with the class pixel value of the further class, are modified. This allows a component of the examination object, which corresponds to the further class pixel value, to be added to the second image later. The modification preferably takes place by allocating the class pixel value of the further class.

It is particularly advantageous if the classification of the pixels in classes is verified, by comparing the calculated projection data with the measured projection data. The better the classification corresponds to the actual circumstances of the examination object, the better the calculated projection data should also correspond to the measured projection data. If the correspondence is inadequate, the classification can therefore be adjusted. It is possible to proceed in an iterative manner here. In particular it is possible not to take account of the data range of the normalized projection data to be modified during the comparison. This is based on the consideration that this data range is an unreliable range in need of correction, which is therefore not considered during the comparison.

In the normalized projection data the values can be modified by using an interpolation method. For interpolation values are used, which are not to be modified. A linear interpolation method is particularly suitable because of its simplicity of calculation. However it is also possible to use other, in particular more complex and therefore better, interpolation methods.

At least one embodiment of the inventive control and computation unit serves to reconstruct image data of an examination object from measurement data of a CT system. It comprises a program storage unit for storing program code, in which—in some instances among other things—program code is present, which is suitable for executing a method of the type described above. The inventive CT system comprises such a control and computation unit. It can also contain other components, which are required for example to capture measurement data.

At least one embodiment of the inventive computer program has program code segments, which are suitable for implementing the method of the type described above, when the computer program is executed on a computer.

At least one embodiment of the inventive computer program product comprises program code segments stored on a computer-readable data medium, said program code segments being suitable for implementing the method of the type described above, when the computer program is executed on a computer.

### BRIEF DESCRIPTION OF THE DRAWINGS

The invention is described in more detail below with reference to an example embodiment shown in the figures, in which:

FIG. 1: shows a first schematic diagram of an example embodiment of a computed tomography system having an image reconstruction component,

FIG. 2: shows a second schematic diagram of an example embodiment of a computed tomography system having an image reconstruction component,

FIG. 3: shows a flow diagram,

FIG. 4: shows three CT images,

FIG. 5: shows three CT images, which represent enlarged segments of the CT images in FIG. 4.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

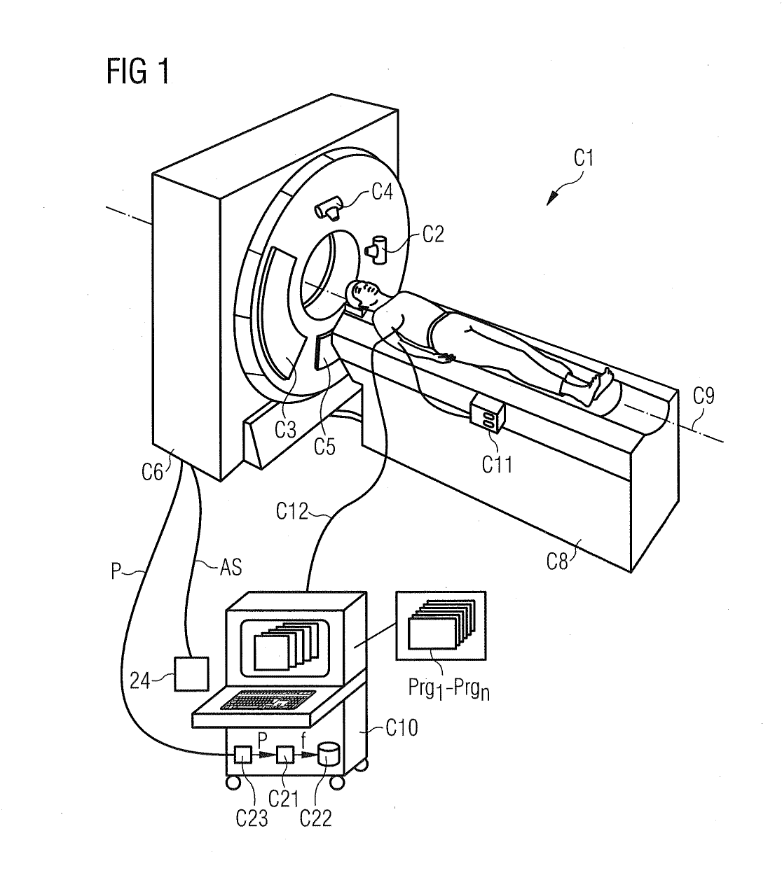

FIG. 1 first shows a schematic diagram of a first computed tomography system C1 having an image reconstruction facility C21. Located in the gantry housing C6 is a closed gantry (not shown), on which a first x-ray tube is disposed with a detector C3 opposite it. A second x-ray tube C4 with a detector C5 opposite it is optionally disposed in the CT system shown here so that a higher time resolution can be achieved by the additionally available emitter/detector combination or “dual energy” examinations can also be carried out using different x-ray energy spectra in the emitter/detector systems.

The CT system C1 also has a patient couch C8, on which a patient can be moved along a system axis C9, also referred to as the z-axis, into the measurement field during the examination, it being possible for the scan itself to take place both as a purely circular scan exclusively in the examination region of interest without the patient being advanced. In this process the x-ray source C2 and/or C4 respectively rotates about the patient. The detector C3 and/or C5 travels along opposite the x-ray source C2 and/or C4 to capture projection measurement data, which is then used to reconstruct sectional images. As an alternative to a sequential scan, during which the patient is moved gradually through the examination field between the individual scans, there is of course also the option of a spiral scan, during which the patient is moved continuously along the system axis C9 through the examination field between the x-ray tube C2 and/or C4 and the detector C3 and/or C5 while being scanned in a rotating manner with the x-ray radiation. The movement of the patient along the axis C9 and the simultaneous rotation of the x-ray source C2 and/or C4 result in a helical path for the x-ray source C2 and/or C4 relative to the patient during measurement in a spiral scan. This path can also be achieved by moving the gantry along the axis C9 while the patient remains stationary.

The CT system 10 is controlled by a control and computation unit 010 with a computer program code Prg₁ to Prgₙ present in a storage unit. Acquisition control signals AS can be transmitted from the control and computation unit C10 by way of a control interface 24, to activate the CT system C1 according to certain measurement protocols.

The projection measurement data p acquired by the detector C3 and/or C5 is transferred by way of a raw data interface C23 to the control and computation unit C10. This projection measurement data p is then optionally processed further in an image reconstruction component C21 after suitable preprocessing. The image reconstruction component C21 in this example embodiment is realized in the control and computation unit C10 in the form of software on a processor, e.g. in the form of one or more of the computer program codes or program code segments Prg₁ to Prgₙ. The image data f reconstructed by the image reconstruction component C21 is then stored in a storage unit C22 of the control and computation unit C10 and/or output in the conventional manner on the screen of the control and computation unit C10. It can also be fed by way of an interface (not shown in FIG. 1) into a network connected to the computed tomography system C1, for example a radiological information system (RIS), and be stored in a mass storage unit accessible there or be output as images.

The control and computation unit C10 can also execute the function of an ECG, with a line C12 being used to divert the ECG potentials between the patient and the control and computation unit C10. The CT system C1 shown in FIG. 1 also has a contrast agent injector C11, by way of which contrast agent can also be injected into the blood circulation of the patient, so that the vessels of the patient, in particular the heart chambers of the beating heart, can be shown more clearly. It is also thus possible to carry out perfusion measurements, for which the proposed method is also suitable.

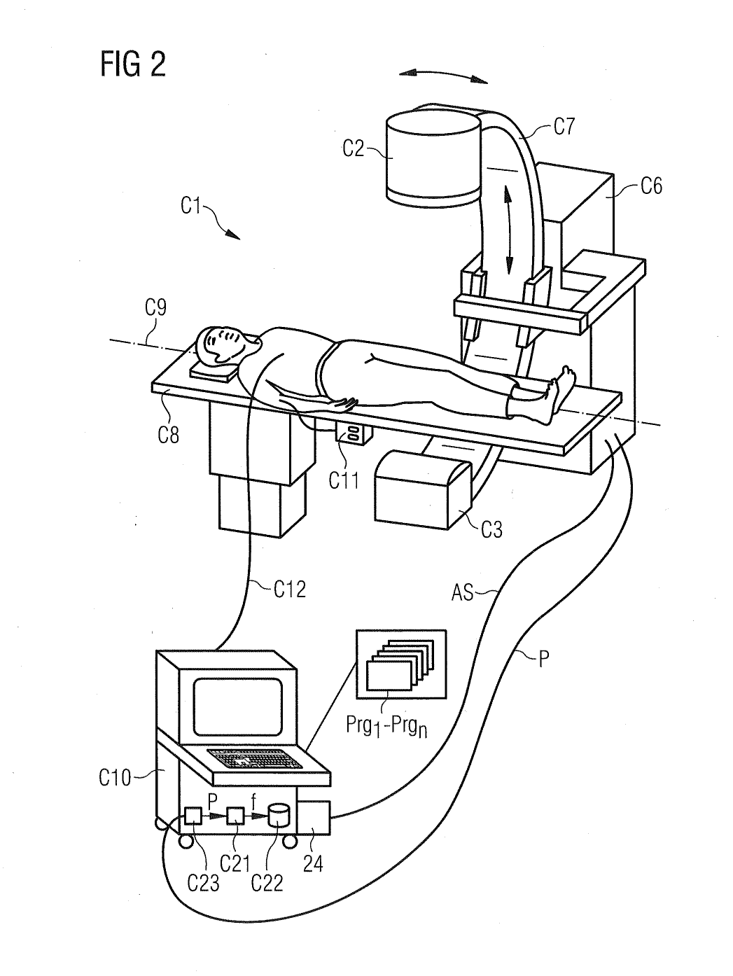

FIG. 2 shows a C-arm system, in which, in contrast to the CT system in FIG. 1, the housing C6 supports the C-arm C7, to which on the one hand the x-ray tube C2 and on the other hand the detector C3 opposite it are secured. The C-arm C7 is also pivoted about a system axis C9 for a scan, so that a scan can take place from a plurality of scan angles and corresponding projection data p can be determined from a plurality of projection angles. The C-arm system C1 in FIG. 2, like the CT system in FIG. 1, has a control and computation unit C10 of the type described in relation to FIG. 1.

An example embodiment of the invention can be used in both the systems shown in FIGS. 1 and 2. It can also be used in principle for other CT systems, e.g. for CT systems with a detector forming a complete ring.

The control and computation unit C10 determines images of the examination object from the projection measurement data. A high image quality is expected in this process, as the examination object has been exposed to an x-ray radiation that is harmful to living examination objects like a patient, as the data is being captured. This should be utilized to the best possible degree.

If the patient to be examined has metal objects in the body, artifacts generally result in the CT images, drastically reducing image quality. The errors produced by metal objects are mainly due to the effects of beam hardening, in other words low energy x-ray radiation is scattered to a much greater degree at the metal objects than higher energy radiation, of the increased noise, which results due to the significant absorption of x-ray radiation by metal objects and thus a significant reduction in the intensity received at the detector, and ultimately on the partial volume effect at the edges of metal objects.

A metal object produces what is known as a metal trace in the sinogram. The sinogram represents a two-dimensional space per detector row, which is spanned on the one hand by the projection angle, i.e. the angular position of the x-ray source relative to the examination object, and on the other hand by the fan angle within the x-ray beam, i.e. the position of the detector pixel. The sinogram space therefore represents the measurement data domain, while the image space represents the image data domain. A back projection allows movement from the sinogram space into the image space, i.e. from the measurement data to the image data, and a forward projection allows the reverse.

The metal trace therefore indicates the region within the sinogram, where the measurement data that represents the projections of the metal object is located. The effect described above means that the metal trace is thus a region within the sinogram, within which the data can be considered to be unreliable. It is therefore a known approach to improving image quality to replace the error-prone data of the metal trace with interpolated data. This can improve the artifact loading of the overall image. However it should be noted that new artifacts can result in the image due to interpolation.

The occurrence of different artifacts with known interpolation methods can be explained as follows:
In regions around the metal objects in particular the image is often extremely blurred due to the artifacts resulting from interpolation, so that information is lost in this region. This is because although interpolation can be used to generate the most consistent data possible, the structure information contained in deleted data is lost. A particularly small region is available in the sinogram for regions around metal objects and therefore particularly little reliable information is available for the interpolation.
Stripes result between deleted metal objects and between other high contrast objects. This is because the transition from measured to artificially added data is not perfect. As described in reference [1], edges result in conventionally interpolated sinograms, in particular in traces of high contrast objects after high pass filtering for the filtered back projection.

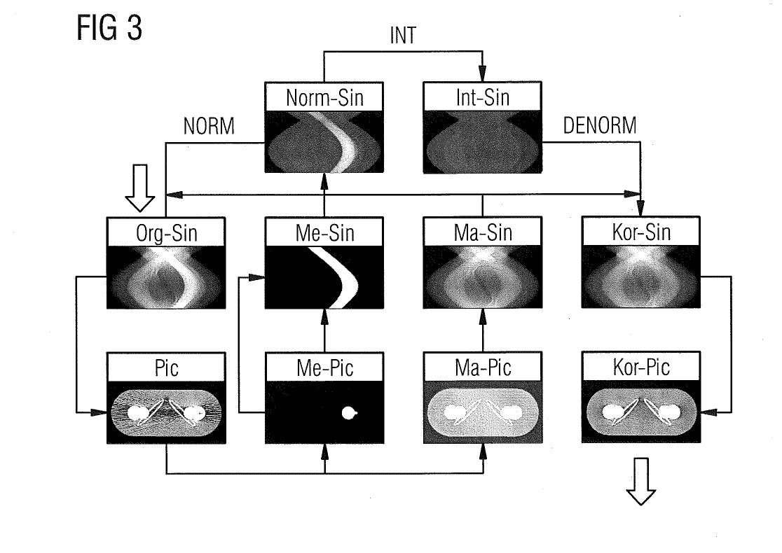

An improved procedure for preventing metal artifacts is described below with reference to FIG. 3. The measurement data serving as the input for the method has already been captured. This is indicated by an arrow on the left side of the diagram. This measurement data corresponds to the original sinogram Org-Sin. An image Pic is reconstructed from the measurement data. Methods known per se can be used for image reconstruction, in particular convoluted back projection. To improve the method it is possible to carry out a smoothing or another type of manipulation of the measurement data in the original sinogram Org-Sin as a preprocessing step before this first image reconstruction. This procedure in particular allows needle-type artifacts caused by the considerable noise of the data in the metal trace to be reduced. This makes the segmentation described in the following more robust.

The image Pic in FIG. 3 shows an example of a sectional image of a patient in the hip region. It shows the two hip joints. The right hip joint has a metal hip implant, with the result that artifacts manifested as horizontal stripes are clearly present within the image Pic.

The image Pic now undergoes segmentation, the result of which is a metal image Me-Pic and a mask image Ma-Pic. During segmentation the procedure is as follows:

The original image Pic consists of pixels, to which an image value is respectively assigned. The image values are indicated as a CT value in HU (Hounsfield Units). These indicate the attenuation value μ of the respective point within the examination object according to

$$CT - Wert = \frac{μ - {μ}_{Water}}{{μ}_{Water}} \cdot 1000 HU$$

relative to the attenuation value of water μ_{Water}. This shows that air, which absorbs almost no x-ray radiation, has a CT value of −1000 HU, tissue a CT value of approximately −100 HU, water by definition a CT value of 0 HU and bone a CT value of approximately 500-1500 HU. Metals produce a much greater absorption of x-rays than bone and therefore have even higher CT values.

The overall CT value range is now divided into a certain number of regions. A specific CT value, which is representative of the respective region, is assigned to each region, e.g. the mean CT value of the region or the upper limit value of the region. This CT value is referred to hereafter as the class value, as the described segmentation corresponds to a classification of the CT values in classes. Each region corresponds to a type of material of the examination object. The use of 4 regions is assumed by way of example in the following. These correspond to the materials air, water, bone and metal.

The HU value of the upper limit of a region can be seen as a threshold value. All the HU values above the preceding and below the threshold value of a specific region are assigned to the respective region. The threshold values can thus be used to demarcate different materials from one another. In the present example there is a first threshold value to separate air and water, a second threshold value to separate water and bone and a third threshold value to separate bone and metal.

The mask image Ma-Pic is produced from the original image Pic by replacing the CT values with the respective class value. In the mask image Ma-Pic the class value of air, which was set to 0 by way of example, is therefore input for all pixels, the CT value of which in the original image Pic is below the threshold value for demarcating air and water. Also the class value of water, assumed by way of example to be 0.0192/mm, is input for all pixels, the CT value of which in the original image Pic is above the threshold value for demarcating air and water and below the threshold value for demarcating water and bone. Finally the class value of bone is input for all pixels, the CT value of which in the original image Pic is above the threshold value for demarcating water and bone and below the threshold value for demarcating bone and metal. This should be a CT value which corresponds to the mean CT value of bone. To this end for example a suitable CT value can be defined by forming a mean value of the bone pixels of the original image Pic.

There are also pixels which were identified as metal based on the threshold value comparison. These are allocated the CT values of the bone class in the mask image Ma-Pic. Alternatively other CT values could also be used for the metal pixels in the mask image Ma-Pic. These are not used here, as will be seen in the following.

The mask image Ma-Pic therefore contains only three different CT values, i.e. the three class values, each class value corresponding to a type of material. FIG. 3 clearly shows that in the mask image Ma-Pic the bones and the metal implant have a higher class value than the other pixels, as can be seen from the lighter color. Also the area round the outside of the patient, which corresponds to the class value of air, and the tissue of the patient in the hip region, which corresponds to the class value of water, can be differentiated.

In contrast in the metal image Me-Pic only the metal pixels are allocated image values. The CT values used here are irrelevant, since the metal image Me-Pic is only to be used to show the location of the metal trace. Therefore only the hip implant is visible in the metal image Me-Pic.

Of importance for good metal artifact correction is a suitable choice of region limits and class values of the regions. Empirical values can be used for this in the simplest instance. It is also possible to use the original image Pic to create a histogram and to use the histogram to decide where suitable region limits and class values are located. These can be a function for example of the type of tissue mapped by the image Pic and which metal is contained, since the CT values of different metals can also differ.

An adaptive method for determining suitable threshold values can also be used. To this end sinogram data Ma-Sin is calculated from the mask image Ma-Pic by forward projection. This data of the mask image sinogram Ma-Sin can be compared with the original sinogram Org-Sin. This comparison is only carried out using those regions of the two sinograms away from the metal trace. This corresponds to the region within the mask image sinogram Ma-Sin, which should be falsified to the least possible degree by segmentation. A number of region divisions and class values can now be considered, with the resulting mask image sinogram Ma-Sin in each instance being compared with the original sinogram Org-Sin. This can be used to determine the best region limits and class values. This procedure can be rendered more efficient by proceeding in an iterative manner.

An iterative method can be implemented for example in the manner of a gradient descent method, with for example the sum of the squares of the differences between the original sinogram Org-Sin and the mask image sinogram Ma-Sin away from the metal trace being used as the target function to be minimized. The differentiation between the two sinograms Org-Sin and Ma-Sin is effected point by point here. It is verified in each iteration whether this sum has become even smaller than in the previous iteration. In each iteration the region limits and class values are modified gradually in order to carry out the next comparison after new segmentation and new forward projection. The region limits and class values are modified in a descending direction, which can be calculated with the aid of the gradient of the sum of the squares of the difference between the sinograms Org-Sin and Ma-Sin away from the metal trace. Initialization of the values for the first iteration can be selected as described above from empirical values or with the aid of a histogram.

Once segmentation is completed, i.e. when the metal image Me-Pic and the mask image Ma-Pic are present, projection data is calculated from the two images Me-Pic and Ma-Pic by forward projection. The metal sinogram Me-Sin results from this for the metal image Me-Pic. The sole information this contains is the location of the metal trace within the measurement data. The appearance of the metal sinogram Me-Sin corresponds to the theoretical knowledge that a metal object with elliptical cross section present in a tomographic recording layer produces a sinusoidal stripe of variable width within the sinogram.

The mask sinogram Ma-Sin already mentioned above results for the mask image Ma-Pic. This corresponds to a simplified version of the original sinogram Org-Sin, the metal trace not being contained therein. During the forward projection for calculating the mask sinogram Ma-Sin line integrals are calculated over the object mapped in the initial image Ma-Pic. The mask sinogram Ma-Sin therefore indicates the effectively irradiated water length. In other words when a projection goes through bone as well as tissue, the effectively irradiated water length is greater than for a projection that only goes through tissue.

The mask sinogram Ma-Sin is now used to normalize NORM the original sinogram Org-Sin. This normalization NORM is carried out by dividing the values of the original sinogram Org-Sin pixel by pixel, i.e. point by point, by the values of the mask sinogram Ma-Sin. The result of the normalization NORM is the normalized sinogram Norm-Sin. Normalization NORM largely eliminates the structures within the sinogram. This is true in particular of the traces of dense objects, i.e. bones. This is because the effect of the effectively irradiated water length described above is eliminated by the division. A mean projection value therefore results for the entire normalized sinogram Norm-Sin. The elimination of the structure is clearer, the better the segmentation, in other words the more suitable the region limits and class values selected and the more regions used during segmentation.

Elimination of the structure by normalization NORM does not apply to the metal trace, as the CT value of bone was used for this within the mask image Ma-Pic, so its structure was not eliminated by normalization. Therefore the metal trace is still visible in the normalized sinogram Norm-Sin.

However the visibility of the metal trace within the normalized sinogram Norm-Sin is irrelevant here, as the location of the metal trace is known from the metal sinogram Me-Sin. In the following step INT the values of the sinogram Norm-Sin that are within the metal trace are replaced with other values by interpolation. The result of this interpolation is the interpolated sinogram Int-Sin. The simplest option for interpolation is a linear interpolation, with a linear equation then being used to calculate projection values within the metal trace from the projection values away from the metal trace. More complex methods can also be used. After interpolation the resulting sinogram Int-Sin is almost completely structureless.

This replacement of values explains why it is irrelevant which CT values are used for the pixels mapping the metal within the mask sinogram Ma-Sin.

To obtain another sinogram, from which an image can be reconstructed, in a denormalization step DENORM, which is the reverse of the normalization step NORM, the interpolated sinogram Int-Sin is multiplied pixel by pixel, in particular also in the region of the deleted metal trace, by the mask sinogram Ma-Sin. As a result the resulting sinogram Kor-Sin again contains the structure information contained in the mask sinogram Ma-Sin.

In contrast to simple replacement of the metal trace with corresponding data from the mask sinogram Sin-Ma, normalization ensures an almost perfect transition even in traces of high contrast objects. While the data from the mask sinogram Sin-Ma includes the form of the projections and therefore structure information, normalization prevents new artifacts resulting due to poor transitions from measured to artificial data. Also the artificially inserted data is scaled to the correct size, which can vary at different points in the sinogram.

A subsequent image reconstruction supplies the corrected image Kor-Pic. This maps the examination object as if the metal object were not present. In the corrected image Kor-Pic the metal object is not visible, nor are there artifacts produced by the metal object.

The corrected image Kor-Pic can be output as the resulting image. However it is frequently desirable to obtain an image in which the metal object is also visible. To obtain such an image, the pixels where the metal object is located according to the metal image Me-Pic can be replaced in the corrected image Kor-Pic by a high CT value corresponding to the respective metal.

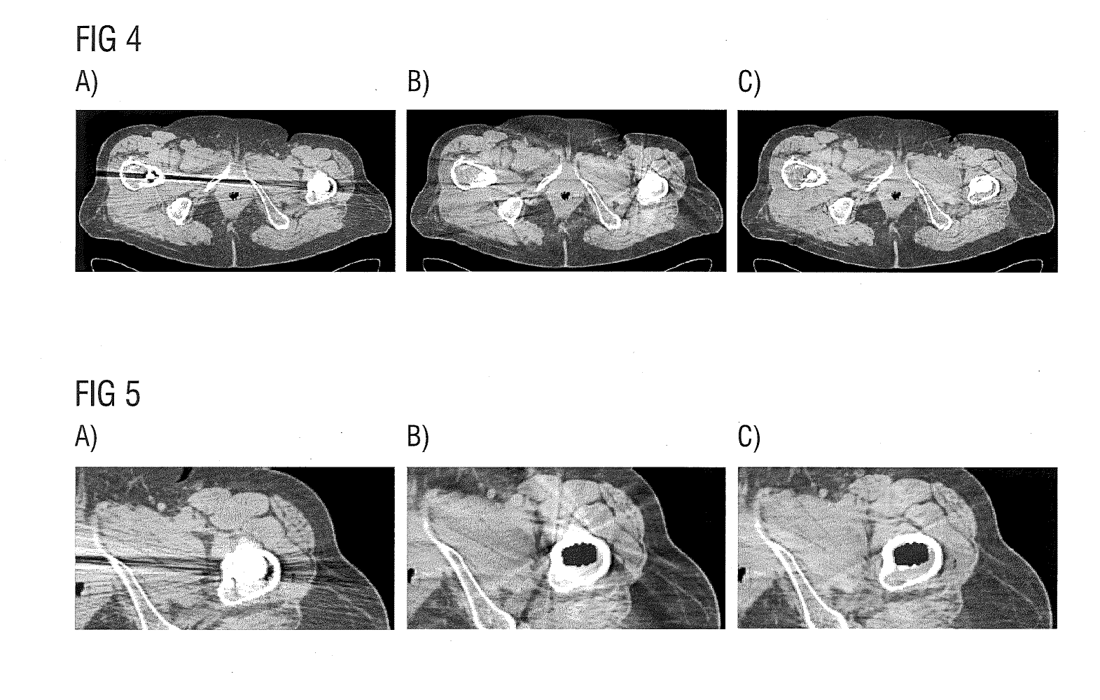

An example application is shown in FIGS. 4 and 5. All the CT images shown in these figures show a sectional image through the hip of a patient. The images in FIG. 5 respectively represent enlarged segments of the corresponding images in FIG. 4, the enlargement only showing the right one of the two hip joints. The patient has two metal hip implants.

Metal objects are frequently at least partially enclosed by bone. This applies not only to hip implants but also for example to spinal fixation devices and dental fillings. Since computed tomography is generally much superior to magnetic resonance tomography when bone and metals are present, so the latter is not used for imaging, it is particularly important to obtain high quality CT images for such situations.

FIG. 4A—and also FIG. 5A in relation to the right hip joint—shows the uncorrected image, corresponding to the image Pic in FIG. 3. The metal objects are the white point within the white shape in the case of the left hip joint and the larger white filled circle within the white shape in the case of the right hip joint. The metal artifacts can be easily identified. They consist primarily of stripes in the image and are most marked in direct proximity to the metal objects and between the metal objects.

FIG. 4B—and also FIG. 5B in relation to the right hip joint—shows an image that would be obtained by linear interpolation in the sinogram according to the prior art, i.e. by interpolation in the original sinogram Org-Sin in FIG. 3. It can be seen that although some artifacts from FIGS. 4A and/or 5A have been eliminated, new artifacts in the form of stripes primarily around the right implant have been added by the interpolation.

FIG. 4C—and also FIG. 5C in relation to the right hip joint—shows an image obtained by means of the method in FIG. 3. It can be seen that on the one hand the artifacts have been considerably reduced. On the other hand the tissue around the metal objects shows much better resolution. This is particularly clear at the tissue within the white shape in FIG. 5C.

The invention has been described above using an example embodiment. It is evident that numerous changes and modifications are possible, without departing from the scope of the invention.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combineable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, computer readable medium and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable medium and is adapted to perform any one of the aforementioned methods when run on a computer device (a device including a processor). Thus, the storage medium or computer readable medium, is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media; such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for reconstructing image data of an examination object from measurement data, the measurement data being data captured as projection data during a relative rotational movement between a radiation source of a computed tomography system and the examination object, the method comprising:
determining a first image from the measurement data;
modifying pixel values of the first image by classifying the pixel values in at least three classes, a class pixel value being assigned to each class, and allocating the pixels of the first image a respective class pixel value;
calculating projection data from the modified first image;
using the calculated projection data to normalize the measured projection data;
modifying values in the normalized projection data;
subjecting the modified normalized projection data to a processing that reverses normalization; and
determining a second image from the processed projection data.

2. The method as claimed in claim 1, wherein
the different class pixel values correspond to image values of different types of components of the examination object.

3. The method as claimed in claim 2, wherein
the different types of component are at least air, water and bone.

4. The method as claimed in claim 1, wherein
a top and bottom pixel value are determined for each class and a pixel is classified in the respective class, if its pixel value is between the bottom and top pixel values of the respective class.

5. The method as claimed in claim 1, wherein in addition to the modification of the first image, a further image is generated, with pixels being allocated the class pixel value of a further class in the further image.

6. The method as claimed in claim 5, wherein the further class pixel value corresponds to image values of metal components of the examination object.

7. The method as claimed in claim 5, wherein
further projection data is calculated from the further image and it is concluded from the further projection data which values of the normalized projection data are to be modified.

8. The method as claimed in claim 5, wherein
the further projection data indicates a location of a metal trace within the measurement data.

9. The method as claimed in claim 5, wherein in the second image, the pixel values of pixels, which correspond to the pixels of the further image with the class pixel value of the further class, are modified.

10. The method as claimed in claim 9, wherein modification takes place by allocating the class pixel value of the further class.

11. The method as claimed in claim 1, wherein the classification of the pixels in classes is verified, by comparing the calculated projection data with the measured projection data.

12. The method as claimed in claim 11, wherein a multiple comparison takes place within the context of an iterative method.

13. The method as claimed in claim 11, wherein the data region of the normalized projection data to be modified is not taken into account during the comparison.

14. The method as claimed in claim 1, wherein values are modified in the normalized projection data by using an interpolation method.

15. The method as claimed in claim 1, wherein the calculated projection data is used to normalize the measured projection data, by dividing the measured projection data by the calculated projection data.

16. The method as claimed in claim 1, wherein the modified projection data is subjected to a processing that reverses normalization, by multiplying the modified projection data by the calculated projection data.

17. A control and computation unit for reconstructing image data of an examination object from measurement data of a CT system, comprising:
a program storage unit for storing program code segments to implement, when executed on the control and computation unit, at least the following,
determining a first image from the measurement data;
modifying pixel values of the first image by classifying the pixel values in at least three classes, a class pixel value being assigned to each class, and allocating the pixels of the first image a respective class pixel value;
calculating projection data from the modified first image;
using the calculated projection data to normalize the measured projection data;
modifying values in the normalized projection data;
subjecting the modified normalized projection data to a processing that reverses normalization; and
determining a second image from the processed projection data.

18. A CT system comprising a control and computation unit as claimed in claim 17.

19. A computer program product, comprising program code segments of a computer program stored on a computer-readable data medium, to implement the method as claimed in claim 1 when the computer program is executed on a computer.

20. The method as claimed in claim 2, wherein
a top and bottom pixel value are determined for each class and a pixel is classified in the respective class, if its pixel value is between the bottom and top pixel values of the respective class.

21. The method as claimed in claim 2, wherein in addition to the modification of the first image, a further image is generated, with pixels being allocated the class pixel value of a further class in the further image.

22. The method as claimed in claim 22, wherein the further class pixel value corresponds to image values of metal components of the examination object.

23. The method as claimed in claim 5, wherein
further projection data is calculated from the further image and it is concluded from the further projection data which values of the normalized projection data are to be modified.

24. The method as claimed in claim 23, wherein
further projection data is calculated from the further image and it is concluded from the further projection data which values of the normalized projection data are to be modified.

25. The method as claimed in claim 12, wherein
the data region of the normalized projection data to be modified is not taken into account during the comparison.

26. A computer readable medium including program segments for, when executed on a computer device, causing the computer device to implement the method of claim 1.
